(19) United States
(12) Patent Application Publication
(10) Pub. No.: US 2005/0173926 A1
(43) Pub. Date: Aug. 11, 2005

(54) GENERATING APPARATUS

(75) Inventor: Tateo Aoyama, Kakegawa-shi (JP)

Correspondence Address: ERNEST A. BEUTLER, ATTORNEY AT LAW, 10 RUE MARSEILLE, NEWPORT BEACH, CA, 92660, US

(73) Assignee: SOQI KABUSHIKI KAISHA, Kakegawa-shi (JP)

(21) Appl. No.: 10/905,850

(22) Filed: Jan. 24, 2005

(30) Foreign Application Priority Data
Feb. 6, 2004 (JP) 2004-031395
Feb. 6, 2004 (JP) 2004-031396
Feb. 6, 2004 (JP) 2004-031397
Feb. 6, 2004 (JP) 2004-031398
Feb. 6, 2004 (JP) 2004-031399

(51) Int. Cl. F02C 6/00; H02K 7/18; H02P 9/04; F01D 15/10

(52) U.S. Cl. 290/1 A

(57) ABSTRACT

An improved power generator having a pair of relatively rotatable elements each of which may be selectively driven in an opposite direction and at a desired speed by one of a pair of oppositely rotating prime movers to vary the power output and achieve a greater maxim power at a lower speed than conventional devices to reduce vibration and provide a longer life. The unit is comprised of a number of interconnected housing elements so that it can be compact, easily assembled and mounted. A clutch and brake arrange is incorporated to facilitate starting of the prime movers and to insure that one does not drive the other particularly in the wrong direction. In addition a cooling arrangement is provided that accomplishes the necessary cooling with respect to the amount op power generated.

### BACKGROUND OF THE INVENTION

This invention relates to an power generating apparatus and more particularly to an improved generator that produces a large power output at a lower driven speed, one that can be easily mounted in its operating location and as a unit, one which may be driven by a pair of internal combustion engines each of which has its own starting mechanism, one in which a wide variety of power outputs can be achieved with minimum power input, one in which the powering units and the output element are well cooled and also an arrangement where the driving members and the driven generating apparatus can be easily and compactly coupled together.

The use of electrical generators powered by a prime mover such as an internal combustion engine are well known. Although various constructions have been proposed, the generator normally is comprised of an armature having a number of ferromagnetic pole teeth around which electrical coils are wound. These coils or more particularly the pole teeth face a plurality of circumferentially spaced permanent magnets and one of the elements, generally the one carrying the magnets is rotated so as to induce a current flow through the coils.

Such an internal combustion engine driven generator is shown in Japanese Published Application JP Hei 8-80095. As is well known the amount of electrical power generated by such a generator is generally proportional to the speed at which it is driven. Therefore when large electrical power outputs are required, the speed of the driving engine is increased.

However when the engine speed is increased, the engine noise may become objectionable. This can be avoided if a step up transmission of some type is interposed between the engine and the generator to increase the rotational speed in relation to the engine speed, but the inertial force of the generator is proportional to the square of the speed at which it is driven, putting increased loading on the bearings and causing vibrations both of which will adversely affect the unit life and increase the need for servicing.

Therefore it is a principal object of the invention to provide a driven generator that can produce greater electrical power without requiring high rotational speeds achieved by either higher engine driving speeds or the use of step up transmissions.

In the co-pending application Ser. No. 10/904,882 of which I am a co-inventor with other and which is assigned to the assignee hereof there is disclosed an electrical generator having two relatively rotatable elements each of which is driven in its respective direction by a prime mover arrangement so as to increase the power output without increasing the driving speed. However all of the embodiments disclosed therein require separate mounting bases for several of the components that makes the mounting of the assembly complicated and may also suffer detrimental effects if alignment is not maintained.

Therefore it is a first principal object of this to provide a power generating apparatus that can produce high power outputs and which is formed as a unitary assembly to facilitate mounting and insure the desired alignment of the various components.

Here it should be noted that although the aforenoted co-pending application produces electrical power output, the same arrangement may be employed for producing power outputted in another form such as fluid power with certain types of pumps.

By driving the generator elements in opposite directions the power can be increased relative to the driving speed avoiding the problems of vibration and noise. In addition it has been discovered that the driving speeds of the prime movers, if two are employed, can be varied independently thus providing a greater range of outputted power. It is therefore a further object of this invention to provide a power generator having a greater range of power outputs at reduced overall driving speed.

If the power generator is an electrical power generator. brushes may be required to output the electrical power. If the component with which the brushes contact is continuously rotated then there might be high wear. Therefore it is a further object of the invention to provide an electrical generator that produces high electrical power when required but which also may be operated in a mode where brush wear is reduced to minimize servicing requirements.

With any power generator, heat dissipation is a problem. Where higher power outputs are obtained by the type of generator shown in the co-pending application, the amount of heat generated can become substantial. It is therefore another principal object of the invention to provide a power generator that has a very effective and compact cooling arrangement.

Where the generator is driven by one or more internal combustion engines. It is also desirable that the engine or engines are also well cooled. In accordance with another feature of the invention to provide cooling for the power generator that also is effective to cool the powering prime mover arrangement.

If the power generator is driven by one or more internal combustion engines, it is desirable that the powering engine or engines have self starters. When this is done, however, it is desirable that the starter or starters do not place a load on the system once the apparatus has started. It is therefore a further principal object of the invention to provide an improved engine driven power generator that embodies at least one electric starter motor that is disengaged when the apparatus has started.

### SUMMARY OF THE INVENTION

A first feature of the invention is adapted to be embodied in a power generating apparatus comprised of a pair of prime movers. There is also a power generating device comprised of a pair of relatively moveable elements adapted to generate a source of power upon movement of one of said elements relative to the other. Each of the prime movers is adapted to move the elements in opposite directions. In accordance with the invention, a housing arrangement encloses the prime movers and the power generating device for mounting as a single unit.

In accordance with another feature of the invention as set forth in the preceding paragraph, the power generating device comprised an electrical generator.

Another feature of the invention also is adapted to be embodied in a power generating apparatus comprised of a pair of prime movers in the form of internal combustion engines. There is also a power generating device comprised of a pair of relatively moveable elements each driven by one of the engines and together adapted to generate a source of power upon movement of one of said elements relative to the other. Each of the engines is provided with a respective starting system.

Another feature of the invention is embodied in a power generating apparatus as set forth in the preceding paragraph and the respective starting systems comprise electric motors that drive the engines through one way clutches.

In accordance with yet another feature as set forth in the immediately preceding paragraph the one way clutches also act as one way brakes.

### BRIEF DESCRIPTION OF THE DRAWINGS

FIG. 1 is a side elevational view of a first embodiment of the invention, with portions broken away and shown in section.

FIG. 2 is an enlarged cross sectional view of the left hand area of the embodiment shown in FIG. 1.

FIG. 3 is an enlarged cross sectional view of the right hand area of the embodiment shown in FIG. 1.

FIG. 4 is a cross sectional view taken along the line 4-4 in FIG. 2.

FIG. 5 is a cross sectional view taken along the line 5-5 in FIG. 3.

### DETAILED DESCRIPTION

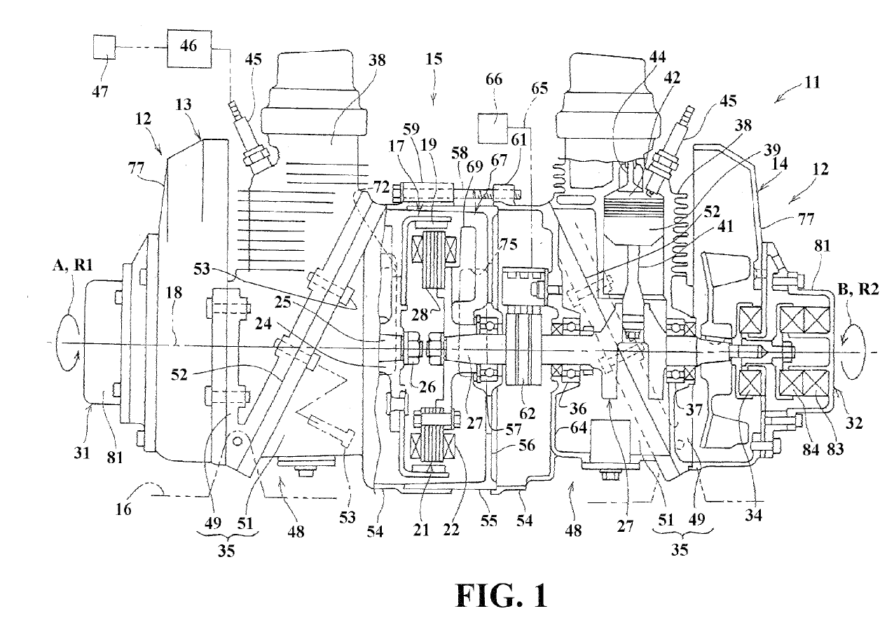

Referring now in detail to the drawings and initially primarily to FIG. 1, the reference numeral 11 indicates generally a power generating unit and specifically in this embodiment an electricity generating unit. The power generating apparatus 11 is made up of a prime mover arrangement, indicated generally by the reference numeral 12, that is in the illustrated embodiment comprised of spaced left 13 and right 14 four-stroke cycle internal combustion engines.

Disposed between the engines 13 and 14 is a power generator 15, specifically in this embodiment an electric generator that is driven by the prime mover arrangement 12 in a manner to be described. This assembly is mounted on a fixed member 16 in the form of a pedestal, for directly supporting the prime mover arrangement 12. The power generator 15 is supported through the prime mover arrangement 12 on the fixed member 16.

The power generator 15 includes a first, generally cup shaped element 17 journalled for rotation about a horizontal axis 18 and supporting a plurality of circumferentially spaced permanent magnets 19. Cooperating with these magnets 19 is a second element 21 also rotatable about the axis 18 and supporting a plural number of generator coils 22 wound around circumferentially spaced pole teeth 23. The magnets 19 and the coils 22 closely face each other about the axis 18. The first rotated element 17 and the second rotated element 21 are supported on the side of the fixed member 16 for rotation about the axis 18.

The first rotated generator element 17 includes a hub part 24 detachably taper-fit to and supported with the free end of a crankshaft portion 25 of the left engine 13 along with the magnets 19 held to the inside round surface of the yoke 16, removably attached to the first rotational crankshaft 25 by a fastener 26 provided at the free end of the first crankshaft 25.

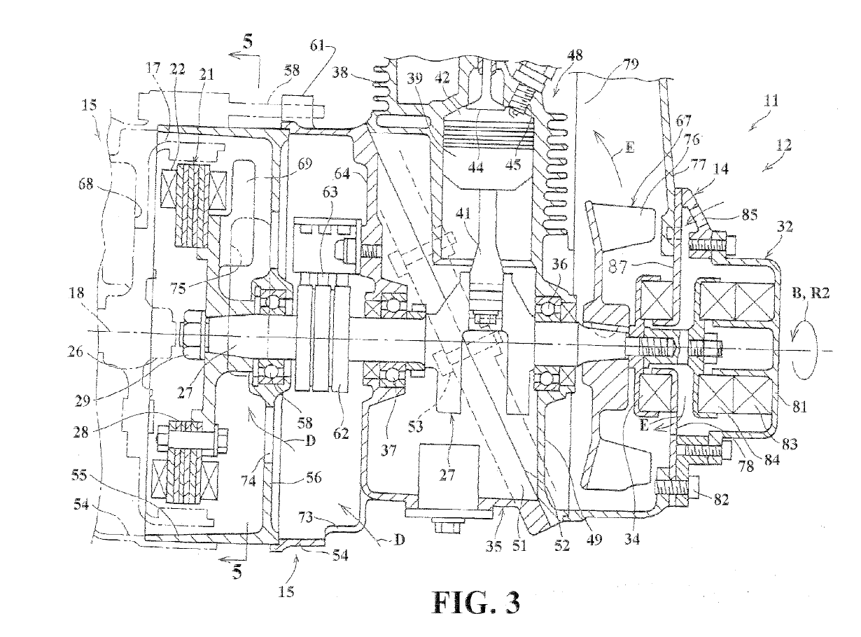

The second rotated generator element 21 includes a second rotational crankshaft 27 of the right engine 14 also rotatable about the axis 18. Fixed to the end of the crankshaft 27 is the core 28 of second generator element which is made of laminated magnetic steel plates around which the coils 22 are wound. As best seen in FIG. 3 these laminations of the core 28 are detachably taper-fit to the free end of the second rotational crankshaft 27 by a threaded fastener 29.

The first and second rotated elements 17 and 21 are placed so that both free ends of the first crankshaft 25 and the second crankshaft 27 closely face each other in the direction of the axis 18. The prime mover arrangement 12 includes the left engine 13 for rotary-driving the first rotated element 17 in one direction A about the axis 18 and the right engine 14 drives the second rotated element 21 in the opposite direction B about the axis 18. The fixed member 16 has spaced lugs for supporting the left engine 13 and the right engine 14 separately from each other.

The end of the first element 21 carrying the magnets 19 and driven by the left engine 13 extends in the direction of the axis 18, further than the free end of the first crankshaft 25 toward the second crankshaft 27. In a like manner an end of the core 28 and the coils 22 on the second crankshaft 27 of the right engine 14 projects more than the free end of the second crankshaft to provide a more compact arrangement. In addition the second crankshaft 27 extends a greater distance from its cylinder bore than that of the first crankshaft 25 from its cylinder bore for a reason that will become apparent as this description proceeds.

The power generating apparatus 11 includes a first starting device, indicated generally at 31, for starting the left engine 13 by rotating it in the direction A about the axis 18. There also is a second starting device 32 for starting the right engine 14 by rotating it in the opposite direction B.

The starting arrangement for the prime mover arrangement 12 also includes a first one-way brake 31 interposed between the left engine 13 and the first starting device 31 to permit the rotation of the first rotated element 17 only in the one direction A through the left engine 13. In a like manner, a second one-way brake 32 is interposed between the right engine 14 and the second starting device 32 to permit the rotation of the second rotated element 21 only in the opposite direction B through the right engine 14. Alternatively, only one of the first and second one-way brakes 31 and 32 may be provided.

Each of the engines 13 and 14 includes a crankcase 35 made by aluminum alloy casting and supported a respective lug of the fixed member 16. In addition each engine 13 and 14 has its crankshaft 25 and 27 supported with a plural number (a pair) of bearings 36, 37 in the respective crankcase 35 for respective rotation about the axis 18.

Each engine 13 and 14 has a cylinder block 38 formed by aluminum alloy casting and projecting vertically upward from the crankcase 35 and which forms a respective cylinder bore in which a piston 39 reciprocates. As is common in the engine art, a connecting rod 41 connects the pistons 39 to their respective crankshaft 38 for its rotation.

The piston 39 and cylinder block 38 of each engine form a respective combustion chamber 42. As is well known in the art intake and exhaust passages serve the combustion chambers 42 to admit a combustible charge (formed in any desired manner) to them and to discharge the burnt charge to the atmosphere through a suitable exhaust system. One such flow passage is shown at 43 along with a respective flow controlling valve 44 that is operated in any desired manner.

The charge in the combustion chambers 42 of the left and right engines 13 and 14 is ignited, for example, by a spark plug 45 that is fired by a respective ignition system 46 (only one of which is shown in conjunction with the left engine 13. These ignition systems 46 are operated in any desired manner and may receive inputs from one or more sensors, indicated schematically at 47. Again it is to be understood that the engines 13 and 14 may have any desired configuration and/or type except as will be hereinafter described.

The speed of each engine 13 and 14 may also be controlled in any desired manner, such as by well known throttle valves in their induction systems, and independently of each other, as will be described later in more detail.

As previously mentioned, the construction of the left and right engines 13 and 14 and their operation and speed control may be of any type and although spark ignited engines have been shown either or both may be Diesel or rotary type if desired. However, in accordance with the invention, the crankcase 35 and the cylinder block 38 of each engine 13 and 14 constitute a portion of an outer shell assembly, indicated generally at 48. The cylinder block 38 and one part, indicated at 49, of the crankcase 35 of the left engine 13 are respectively of the same size and shape as the cylinder block 38 and the one part 49 of the crankcase 35 of the right engine 14.

Each of the crankcase portions 49 of the left and right engines is completed to form the respective crankcase 35 by a second crankcase member, each indicated by the reference number 51. These portions of each crankcase assembly 35 are generally the same but that of the right engine 14 is slightly different because of the greater length of the crankshaft 27 than that of the crankshaft 25 of the left engine 13.

The second crankcase parts 51 are each fixed to respective cylinder blocks 38 along oppositely inclined faces 52 thereof that mate with like inclined faces of the cylinder blocks 38 by respective threaded fasteners 53 that are received in tapped holes in the cylinder blocks 38.

Facing outer ends 54 of the second crankcase parts 51 are enlarged and cylindrical in shape. Because of the longer length of the crankshaft 27 from that of the crankshaft 25 the second crankcase part 51 of the right engine 14 is longer than the corresponding part 51 of the left engine 13. Nevertheless the facing ends 54 are still spaced from each other in the direction of the axis 18.

To fill this gap and to provide additional rotational support for the longer crankshaft 27 a cylindrical bridging member 55 is interfitted between the crankcase portions 51. The bridging member 55 has a wall 56 that supports another bearing 57 is provided so that the crankcase 35 provides further support for the crankshaft 27.

The opposing portions 54 of the outer shell members 48 of the first and second engines 13, 14 are removably secured to each other with the bridging member 55 sandwiched between them using a plural number of (four) fasteners 58. These fasteners 58 pass through bosses 59 formed in one of the portions (that of the left engine 13 as shown) and received in tapped bosses 62 in the other portion.

Both the opposing portions 54 and the bridging member 55 are made in a cylindrical shape to face each other on the axis 18. The projecting ends of the opposing portions 54 are made in complementarily stepped shapes to detachably fit to the bridging member 55 and to control the spacing between the ends of the crankshafts 25 and 27.

The entire power generator 15 is housed in the internal space of the opposing portions 54 and the bridging member 55. The first and second engines 13 and 14, and the first and second rotated elements 17 and 21 may be separated from each other in the direction of the axis 18 as the fastening pieces 58 are unfastened. As they are separated, the first and second rotated elements 17 and 21 are exposed respectively out of the power generator 15. On the other hand, as the second rotated element 21 is attracted toward the magnets 19 with the magnetism of the magnets 19 of the power generator 15, the mutual fitting of the opposing portions 54 up to the desired dimension is assisted.

One part 51 of the crankcase 35 is coupled to the cylinder block 38 of each of the engines 13 and 14 to form a single body that supports the respective crankshaft 25 and 27 between the bearings 36 and 37. The cylinder block 38 crankcase part 49 of each of the engines 13 and 14 carries the bearing 36. The crankcase part 51 of the crankcase 35 of each engine 13 and 14 carries the bearing 37.

As has also been noted, the mating surface 52 of the respective parts 49 and 51 of each of the crankcases 35 slants downwardly in a straight line so as to be more distant from the facing outer end 54 in the direction of the axis 18. Also as has been noted, the one parts 49 and 51 of the crankcase 35 are removably secured to each other using a plural number of threaded fasteners 53 with their axes extending perpendicular to the mating surfaces including the surface 52.

Referring now primarily to FIG. 3, the power generator 15 includes a plurality of slip rings 62 (three in the illustrated embodiment), located on the axis 18, supported with and rotating together with the second crankshaft 27. These slip rings 62 thus also rotate in unison with the core 28 of the generator 15 and are electrically connected to respective ends of the windings of the coils 22, as is well known in the art.

Cooperating with the slip rings 62 are a plurality of brushes 63, supported by the other part 51 of the crankcase 35 and specifically from a wall 64 thereof that carries the bearing 37. As is also well known in the art, the slip rings 62 transmit the electrical power from the coils 22 to the brushes 63.As shown schematically in FIG. 1, an electrical wire 65 for conducts the power from the brushes 63 to an electricity receiving device 66 such as an external battery.

From the foregoing description it should be readily apparent that the construction is very robust and the axial alignment of the various components is maintained with high rigidity. This facilitates the mounting of the complete power generating unit as a unit. However this also results in some problems in connection with the cooling of the engines 13 and 14 and the power generator 15, each of which generates heat in its operation.

Therefore, the power generating unit 11 is provided with an air type cooling device, indicated generally by the reference numeral 67, which is comprised of a plurality of fans. The cooling device 67 includes: a first cooling fan 68 supported with and rotating together with the first generator element 17 and specifically formed integrally with its hub portion 24 and a second cooling fan 69 supported with and rotating together with the second generator element 21 and specifically integrally with the portion connecting it to the crankshaft 27.

These fans 68 and 69 cool the electrical generator 15. The fan 68 operates by drawing atmospheric air through a first air intake opening 71 formed in the lower part of the opposing portion 54 of the crankcase 35 of the left engine 13. This air passes across the elements of the electrical power generator 15 and the heated air is discharged through a first air discharge opening 72 formed radially outside the first cooling fan 68 in the upper part of the opposing portion 54 of the crankcase 35 of the left engine 13. This air flow is represented by the arrows C in the drawings.

In addition, a second air intake opening 73 is formed in the lower part of the facing outer end 54 of the crankcase 35 of the right engine 14. This permits atmospheric air drawn by the action of the fan 69 to enter and pass through a communication passage 74 formed in the partition wall 56. The air then passes through the interior of the bridging member 55 to cool the electrical generator and pass out of a second air discharge opening 75 formed radially outside the second cooling fan 69 in the upper part of the bridging member 55 as shown by the arrows D.

In addition to the aforedescribed cooling system 67 for the electrical generator 15, it also includes an engine cooling fan 76 secured to the other end of the crankshafts 25 and 27 of the left and right engines 13 and 14, respectively. A respective cowling 77 is secured to each of the crankcases 35 of the left and right engines 13 and 14 to partially cover each engine cooling fan 76. An air intake opening 78 is formed in the outer face and lower portion of the cowling 77. In addition, an air discharge opening 79 is formed in the upper part of the cowling 77 in facing relation to the respective cylinder block 38 to permit cooling air flow in the direction of the arrows E.

In the illustrated embodiment, the first and second starting devices 31, 32 comprise recoil starters each including a respective housing 81 secured to the crankcase 35 of the respective engine 13 and 14 through its cowling 77 by means of threaded fasteners 82. The starters 31 and 32 each include a respective recoil rope 83 contained in the housing 81 with one end comprising a grip portion (not shown) exposed outside the housing 81. A respective starter clutch 85 contained in the housing 81 permits the transmission of pulling action of the recoil rope 83 to the crankshaft 38 only when a pulling force is applied.

The housing 81 is placed to cover the air intake opening 78 of the cowling 77, and is provided with another air intake opening 85 for air to enter the air cooling system of each of the engines 13 and 14.

The one-way brakes 33 and 34 are each interposed between the outer end of each crankshaft 25 and 27 and a stopper plate 87 secured to the cowling 77 using the threaded fasteners 82 and other fastening pieces. If the first element 17 tends to rotate together with the crankshaft 25 in a direction opposite the one direction A, or if the second element 21 tends to rotate together with the crankshaft 27 in a direction opposite the direction B, the first and second one-way brakes 33, 34 engage with the crankcase 35 through the stopper plate 87 and the cowling 77, to act as a one way brake so that the elements are prevented from rotating in the respectively reverse directions.

On the other hand, when the first and second engines 13, 14 operate and both the crankshafts 25 and 27 rotate by themselves in their respective normal directions A and B, the first and second one-way brakes 33, 34 and both the starter brakes 84 are released and the crankshafts 25 and 27 can turn freely.

Because of this arrangement each of the engines 13 or 14 may be started independently of the other without causing the other engine to be driven in a reverse direction from its normal rotation. In a like manner if both engines 13 and 14 are being operated either one may be stopped without causing the other to be driven in a reverse direction.

When both of the engines 13 and 14 are operated, the left engine 13 rotary-drives the first rotated element 17 in one direction A while the right engine 14 rotary-drives the second rotated element 21 in the opposite direction B from the one direction A. As a result, the magnets 19 and the coils 22 rotate in opposite directions to magnify the electrical power relative to machines where only one of the elements is rotated and the other is fixed. Thus electric current is generated in the coils 22 and outputted as a three-phase alternate current through the slip rings 62, the brushes 63, and the electrical wire 65 to the electricity receiving device 66.

In the above case, it is made possible to regulate the rotary speeds (R1 and R2) of the first and second engines 13 and 14 respectively by the operation of by way of example the firing of the spark plugs 45 or throttle valves of the first and second engines 13 and 14 by the operation of the controller 46, at the respective absolute rotary speeds R1 and R2.

To put it more specifically, the rotary speeds of the first and second engines 13, 14 may be optionally and individually chosen to be at any of low speed (3000 rpm in the eco-mode), high speed (5000 rpm), and normal speed (4000 rpm). This choice makes it possible for example to operate the power generating apparatus 11 in a state in which the absolute rotary speed R2 of the second rotated element 21 is higher than the absolute rotary speed R1 of the first rotated element 17. It is also possible to operate only one of the first and second engines 13 and 14.

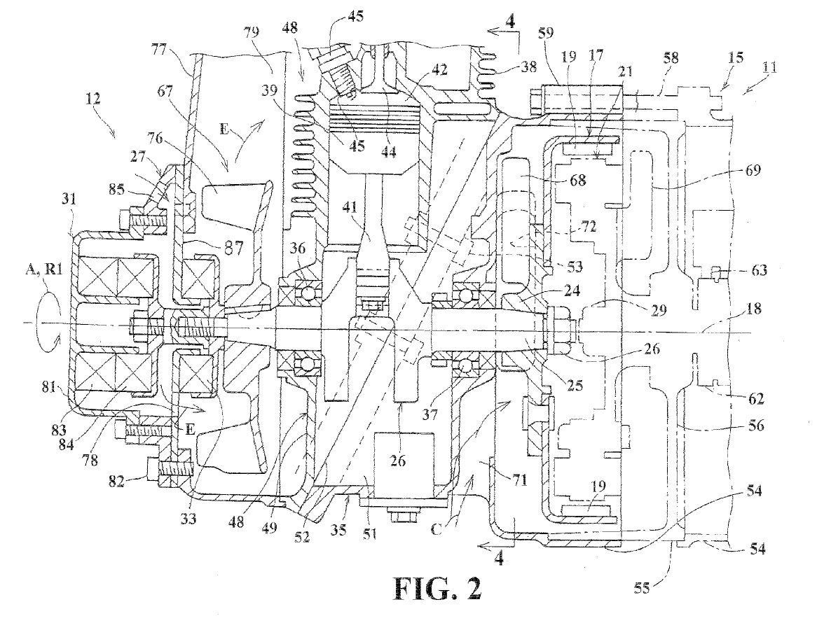

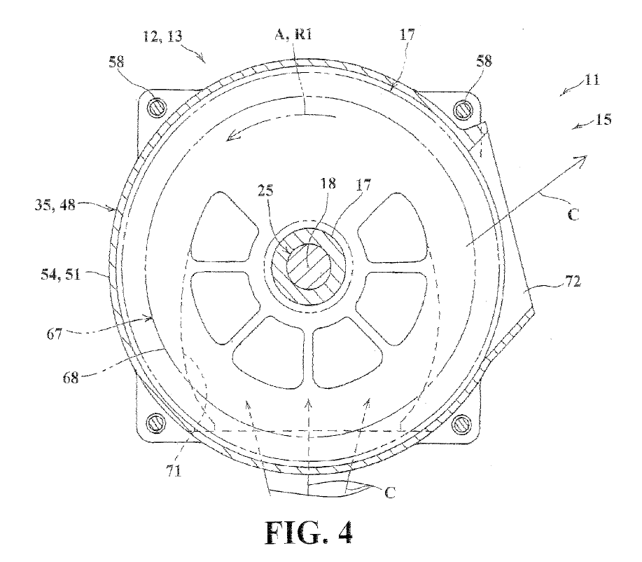

As has been noted, the rotary motion of the crankshaft 25 of the left engine 13 is transmitted to the first cooling fan 68 which causes air present below the power generator 15 of the power generating apparatus 11 to be drawn through the first air intake opening 71 to the interior of the opposing portion 54 of the crankcase 35 of the left engine 13 to air-cool the first rotated element 17 and the magnets 19, then is discharged to the atmosphere through the first air discharge opening 72 in upper part of the power generator 15 as shown by the arrows C in FIGS. 2 and 4. Thus if only the engine 13 is operated there will be enough air flow to cool the electrical generator, considering it will not produce maximum power and accordingly maximum heat.

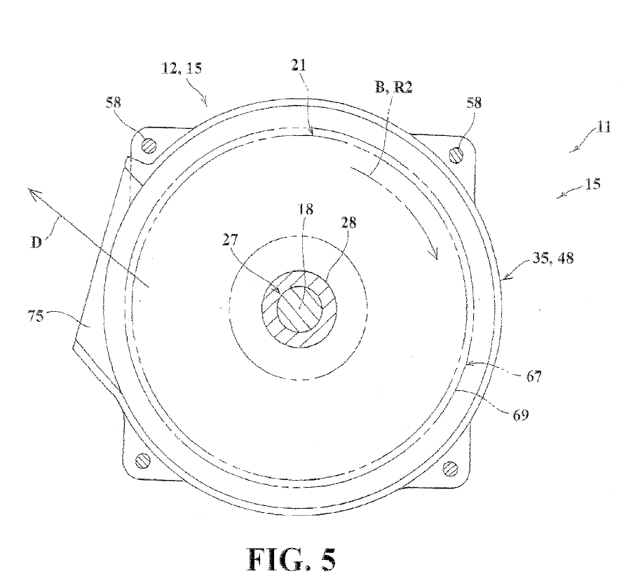

In a similar manner,. the rotary motion of the crankshaft 27 of the right engine 14 drives the second cooling fan 69 which causes air present below the power generator 15 of the power generating apparatus 11 to be drawn through the second air intake opening 73 to the interior of the crankcase portion 54 to air-cool the slip rings 62 and the brushes 63. After that, the air is drawn through the communication passage 74 to the interior of the projecting end 59 of the bridging portion to cool the second rotated element 21 and the coils 22, then through the second air discharge opening 75 to the atmosphere as shown by the arrows D in FIGS. 3 and 5. Thus if only the engine 14 is operated there will be enough air flow to cool the electrical generator, considering it will not produce maximum power and accordingly maximum heat.

When both engines 13 and 14 are operated the greater heat generated by the generator 15 will be dissipated adequately by the operation of both cooling air flows. In this regard it should be noted that when only the engine 13 is operated the slip rings 62 will not be rotated so there will be no significant heating in this area to require cooling.

In a similar manner, the cooling systems 67 for the engines 13 and 14 comprised of the fans 76 only operate when necessary, that is when the respective engine 13 and/or 14 is started and running. Along with the rotary motions of either or both of the crankshafts 25 and 27 the respective engine cooling fans 76 will rotate. This causes external air to be drawn through the other air intake openings 85 to the interior of respective housings 81 of the first and second starting devices 31 and 32 to air-cool the starter clutches 84. After that, the air is drawn through the air intake openings 78 to the interior of the cowlings 77 to air-cool the first and second one-way brakes 33, 34, then discharged through the air intake openings 78 of the cowlings 77 toward the cylinders 38 to air-cool the cylinder block 38 as shown by the arrows E in FIGS. 2 and 3. Incidentally, because the first and second one-way brakes 33 and 34 normally do not contact the crankshafts 25 and 27, the air-cooling described above is not always necessary.

As has been noted, it is possible to individually change the absolute rotary speeds R1, R2 of the first and second rotated elements 17 and 21 by respectively changing the rotary speeds of the first and second engines 13 and 14 or even stop one of them while the other continues to operate to set the power generating apparatus 11 to an intended state of operation. Because the first and second elements 17 and 21 are rotated in opposite directions from each other, the relative speed between the both elements 17 and 21 can be increased, even with the respective rotation speed of the elements 17 and 21 is small. Therefore, the generation output can be drastically increased to be doubled, for example, compared to the prior art where only one of the elements is rotated at the same rotation speed as above. Such an increase in the generation output derives not simply from a high rotation speed of the rotors, but from the first and second rotors 17 and 21 being rotated in opposite directions. In other words, since the generation output can be increased even when the engines 13 and 14 for driving the first and second elements 17 and 21 is driven at a lower speed, which can be achieved while suppressing noise from the engines 13 and 14.

In addition since an increase in the generation output does not rely solely on an increase in the rotation speed of the elements 17 and 21 as described above, the rotation speed of the elements 17 and 21 can be kept low so as not to cause large vibrations in the elements 17 and 21, thereby preventing problems with the service life of the generating apparatus 11 while achieving an increase in the generation output.

Since the brushes 63 and slip rings 62 are associated with the element 21 driven by the engine 14 it would be preferable either not operate the engine 14 or to run it at a lower speed than the engine 13 to reduce wear on these components.

In the case single-phase alternating current is to be outputted with the power generating apparatus 11, the number of the slip rings 22 may be two. To output in two kinds, three-phase alternating and single-phase alternating, five slip rings 22 in all suffice.

The opposing portions 54, of the outer shell assemblies 48 of the first and second engines 13 and 14 opposing each other on the axis 18 are secured to each other. As a result, the first and second engines 13 and 14 are joined together more directly, so that a common framework for supporting the first and second engines 13, 14 may be dispensed with, and bringing the power generating apparatus 11 to an intended state of operation may be accomplished with a simple construction and the rigidity of the power generating apparatus 11 as a whole may be achieved without an increase in the weight of the power generating apparatus 11. Also because the opposing portions 54 and bridging member 55 are made in a cylindrical shape the rigidity of the power generating apparatus 11 as a whole may be accomplished without employing a separate reinforcing member. This also facilitates assembly and disassembly and the interposition of the electrical generator 15 adds to its protection and the overall strength and compactness.

It should be noted that the aforedescribed structure well meets the objects of the invention. However those skilled in the art will readily understand that various modifications may be made without departing from the scope of the invention, as set out in the appended claims. For example only, the power generator 15 may be directly supported with the fixed member 16 and /or, the power generator 15 may be a liquid pump where the first rotated element 17 comprises a pump housing, and the second rotated element 21 is an impeller. Furthermore, the engines 13 and 14 and the power generator 15 need not be placed on the same axis 18. Also, the fixed member 16 may or may not be a common framework for the first and second engines 13 and 14. Furthermore, the power generator 15 may be connected to interlock with the first and second engines 13 and 14 through an interlocking means such as a V-belt girdling mechanism. The magnets 19 may be constituted with coils energized through slip rings from outside. The axis 18 may be vertical or tilted.

As other possible modifications within the general concept of the invention, either or both the first and second engines 31 and 33 may be of the two-cycle type and their specifications may be freely selected in terms of number of cylinders, total displacement, and engine layout such as in-line type, V-type, and the like. The specifications of the engines may be different from each other. Also, the first and second starting devices 31 and 32 may use an electric motor as a drive source. As noted above, those skilled in the art will readily understand that various other modifications than those specifically mentioned may be made without departing from the scope of the invention, as set out in the appended claims.

1. A power generating apparatus comprised of a pair of prime movers, a power generating device comprised of a pair of relatively moveable elements adapted to generate a source of power upon movement of one of said elements relative to the other, each of said prime movers being adapted to move said elements in opposite directions, and a housing arrangement enclosing said prime movers and said power generating device for mounting as a single unit.

2. A power generating apparatus as set forth in claim 1 wherein the prime movers each drive shafts that rotate around respective axes and the relatively moveable elements also rotate about respective axes and all of said axes are coincident.

3. A power generating apparatus as set forth in claim 2 wherein portions of outer shell portions of the prime movers surround the respective drive shafts and oppose each other and are secured together.

4. A power generating apparatus as set forth in claim 3 wherein the power generating device is contained within the connected outer shell portions and a bridging member sandwiched therebetween.

5. A power generating apparatus as set forth in claim 4 wherein the prime movers comprise internal combustion engines and the drive shafts comprise crankshafts journalled within the joined outer shell portions.

6. A power generating apparatus as set forth in claim 5 wherein the bridging member also has a wall portion carrying a bearing for one of the crankshafts.

7. A power generating apparatus as set forth in claim 5 wherein the portions of the joined outer shell are cylindrical in shape.

8. A power generating apparatus as set forth in claim 5 wherein the power generating device comprises an electrical generator having a pair of cooperating elements each of which is affixed for rotation with a respective one of the crankshafts..

9. A power generating apparatus as set forth in claim 8 wherein the electrical generator has a plurality of slip rings connected to the ends of electrical coils wound around poles of one of the cooperating elements and brushes engaging said slip rings for receiving generated electrical power.

10. A power generating apparatus as set forth in claim 9 wherein the bridging member also has a wall portion carrying a bearing for one of the crankshafts and the slip rings are carried between the wall and the other bearing for the one crankshaft.

11. A power generating apparatus as set forth in claim 2 wherein the power generating device comprises an electrical generator first element has a cup shaped portion carrying a plurality of circumferentially spaced permanent magnets and rotatably coupled to the drive shaft of one of the prime movers and the electrical generator second element comprised a core having a plurality of pole teeth in confronting relation to said permanent magnets and fixed to the drive shaft of the other prime mover.

12. A power generating apparatus as set forth in claim 11 wherein the electrical generator has a plurality of slip rings connected to the ends of the electrical coils and brushes engaging said slip rings for receiving generated electrical power.

13. A power generating apparatus as set forth in claim 12 wherein the prime movers are separately operated at variable speeds.

14. A power generating apparatus as set forth in claim 13 wherein one of the prime movers also need not be running to generate electrical power.

15. A power generating apparatus as set forth in claim 2 wherein the prime movers comprise internal combustion engines and further including first and second starting systems for starting the first and second engines.

16. A power generating apparatus as set forth in claim 15 further including at least one of a first one-way brake for permitting the first rotating element to rotate only in the one direction and a second one-way brake for permitting the second rotating element to rotate only in the opposite direction.

17. A power generating apparatus as set forth in claim 16 further a first one-way clutch for connecting the first starting system to the first engine and a second one-way clutch for connecting the second starting system to the second engine, said first and said second one way clutches connecting the starting devices to the respective engines in opposite directions.

18. A power generating apparatus as set forth in claim 4 further comprising cooling fan blades on at least one of the rotating elements of the power generating device for cooling said power generating device.

19. A power generating apparatus as set forth in claim 18 further comprising air flow openings formed in at least one of the connected shell portions for permitting atmospheric air flow therethrough.

20. A power generating apparatus as set forth in claim 18 wherein air flow openings are formed in both of the connected shell portions for permitting atmospheric air flow therethrough.

21. A power generating apparatus as set forth in claim 20 wherein cooling fan blades are formed on both of the rotating elements of the power generating device for cooling said power generating device.

22. A power generating apparatus as set forth in claim 21 wherein the prime movers comprise internal combustion engines and further including third and fourth cooling fan blades for cooling respective of said engines.
